(19) United States
(12) Patent Application Publication
(10) Pub. No.: US 2009/0059137 A1
(43) Pub. Date: Mar. 5, 2009

(54) METHOD FOR DESIGNING DISPLAY MODULE AND LIQUID CRYSTAL DISPLAY OF ADOPTING THE METHOD

(75) Inventor: Ko-Chiang LO, Kaohsiung (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: ARIMA DISPLAY CORPORATION, Kaohsiung (TW)

(21) Appl. No.: 11/845,897

(22) Filed: Aug. 28, 2007

(51) Int. Cl. G02F 1/1335; G02F 1/13

(52) U.S. Cl. 349/106; 703/5

(57) ABSTRACT

A designing method for a display module is provided. First, set a predetermined chromaticity value. Second, readjust a respective area distribution among a red subpixel, a blue subpixel and a green subpixel in a pixel to produce a simulated chromaticity value close to the predetermined one. Next, compare the predetermined chromaticity value with the simulated one. Then, repeat the step of adjusting the respective area of the red subpixel, the green subpixel and the blue subpixel until a difference between the predetermined chromaticity value and the simulated one is in a predetermined deviation. By means of adjusting the area distribution among the different subpixels, the chromatic aberration of LCD could be improved.

### FIELD OF THE INVENTION

The present invention relates to a designing method for a display module and the liquid crystal display utilizing the same, and more particularly to a designing method for a display module by adjusting the respective area distribution among subpixels to display the desired color and the liquid crystal utilizing the same.

### BACKGROUND OF THE INVENTION

Liquid crystal monitors utilize the liquid crystal to display the word and the image. Liquid crystal itself cannot illuminate, and hence the brightness of the monitor is displayed by means of the reflecting light and the backside auxiliary light. The liquid crystal monitors has become the current most popular display device due to the lightness, the low voltage-driven property, the low electricity-consumption, the colorization and the low prize.

In the history of the development of the liquid crystal monitor, the initial twisted nematic (TN) liquid crystal monitor has evolved to the super twisted nematic (STN) liquid crystal monitor, and then the STN liquid crystal monitor has gradually turned out to be evolved to the thin film transistor (TFT) liquid crystal monitor.

The TN liquid crystal monitor characterizes in the high contrast, the low wavelength-dependence of light-transmittance, the high response, the good performance of levels and hues, the low voltage-driven property, the narrow upper and lower view angle and the higher view angle dependence of middle levels and hues. The STN liquid crystal monitor characterizes in the high multiple signaling, the colorization and the slow response. TFT technique provides the best resolution among the current liquid crystal display techniques and every pixel in the TFT liquid crystal monitor is controlled by four transistors. The TFT liquid crystal monitor is also called as active matrix liquid crystal monitor and is superior in the broader view angle, the high contrast, the high resolution and the faster response than the passive matrix liquid crystal monitor. Therefore, the TFT liquid crystal monitor is quietly suitable for manipulating dynamic images and manufacturing the display with large size.

One of the drawbacks of the STN liquid crystal monitor is the slow response that leads to the trajectory while playing animation. However, when the response of the STN liquid crystal monitor is improved, there generates chromatic aberration thereof

Another drawback of the STN liquid crystal monitor is the low contrast of the white to black image. If the contrast is to be enhanced, the problem of the chromatic aberration also occurs correspondingly.

The white (W) image of the liquid crystal monitor is constituted by the lighting of the red subpixel, the green subpixel and the blue subpixel, and hence the chromaticity of the white image is decided by the respective chromaticities thereof. However, customers sometimes request the respective chromaticities of the red image, the green image, the blue image and the white image. Accordingly, how to satisfy the necessity of the four respective chromaticities becomes the question to be solved.

Please refer to FIG. 1, which depicts a prior art area distribution diagram among a red subpixel, a green subpixel and a blue subpixel in a color pixel. In the illustration of FIG. 1, the respective areas of the red subpixel R1, the green subpixel GI and the blue subpixel B1 are the same. As to the STN liquid crystal monitor/TFT liquid crystal monitor, the arrangement of the respective red subpixel, the green subpixel and the blue subpixel will be adjusted in correspondence to different applications. For example, the red subpixel R1, the green subpixel G1 and the blue subpixel B1 are arranged in the mosaic or triangle form while the dynamic image is desired; the red subpixel R1, the green subpixel G1 and the blue subpixel B1 are arranged in the linear form while the static image is desired.

After the STN liquid crystal monitor is manufactured, the color of the backlight source could be adjusted to revise the chromatic aberration of the white image. Alternatively, the chromatic aberration could be also improved by adjusting the respective chromaticities of the red subpixel, the green subpixel and the blue subpixel. However, the range for adjusting the colority through the backlight source is limited to the proximity of the chromaticity coordinate (0.31, 0.31). If deviating far from the chromaticity coordinate (0.31, 0.31), its corresponding LED equipments should be also modified, which is troublesome. On the other hand, if the respective pigments of the red subpixel, the green subpixel and the blue subpixel are adjusted, the original chromaticities thereof might be also changed that creates an ideal chromaticity of the white image, but the respective chromaticities of the red subpixel, the green subpixel and the blue subpixel may not satisfy the standard specification.

The response time of the STN liquid crystal monitor is direct proportional to the square of the cell gap d. Accordingly, the smaller is the value of the cell gap d, the shorter is the response time, which means the response speed is faster. However, the parameter for the anisotropic reflexion ratio Δn (or Δn*d) must be higher and its corresponding wavelength dispersiveness will be also higher. Hereinafter, the wavelength dispersiveness is defined as

$$D = \frac{Δ {nd}_{at 450 nm}}{Δ {nd}_{at 490 nm}}$$

Please refer to FIG. 2, which depicts a data distribution diagram of the wavelength dispersiveness D versus the anisotropic reflection ratio Δn of a plurality of liquid crystal. In the illustration of FIG. 2 there are 673 data among 17 different kinds of liquid crystals, which shows the direct correspondence between the anisotropic reflection ratio Δn and the wavelength dispersiveness D. Taking the STN liquid crystal monitor for example, in the case of Δnd=0.84 μm, if the normal cell gap d is set as 6.3 μm, the desired anisotropic reflection ratio is 0.84/6.3=0.133, and it is known from FIG. 2 that the wavelength dispersiveness D is 1.11. In order to enhance the response time, set the cell gap d as 4.7 μm, whereby the desired anisotropic reflection ratio is 0.84/4.7=0.179 and it is known from FIG. 2 that the wavelength dispersiveness D is 1.16. Based on the mentioned, the respective values of And while D=1.11 and D=1.16 are obtained as shown in Table 1.

TABLE 1
Values of Δnd for different wavelength dispersiveness

| | Δnd_{at 400 nm} | Δnd_{at 450 nm} | Δnd_{at 500 nm} | Δnd_{at 550 nm} |
|---|---|---|---|---|
| D = 1.11 | 979.9 nm | 912.8 nm | 869.5 nm | 840.0 nm |
| D = 1.16 | 1062.7 nm | 948.2 nm | 881.4 nm | 840.0 nm |

| | Δnd_{at 600 nm} | Δnd_{at 650 nm} | Δnd_{at 700 nm} |
|---|---|---|---|
| D = 1.11 | 819.0 nm | 803.5 nm | 791.7 nm |
| D = 1.16 | 813.1 nm | 794.9 nm | 782.2 nm |

The traditional optical condition are designed as: the twisting angle of the uncharged liquid crystal container LCD (not shown) is 240° and Δnd=0.84 μm; the angle of the upper polarizer (not shown) is 10°; the angle of the upper retardation film (not shown) is 70°; the angle of the lower retardation film (not shown) is 110°; the angle of the lower polarizer (not shown) is 80°, wherein the data under the above optical condition is shown in FIG. 3 and 4. FIG. 3 depicts the calculated wavelength separation curve of the while and black image while the wavelength dispersiveness D=1.11. FIG. 4 depicts the calculated wavelength separation curve of the while and black image while the wavelength dispersiveness D=1.16. It is known from FIGS. 3 and 4 that the black image displays towards blue while the wavelength dispersiveness D=1.16. Further, based on the observation, there will be a significant color deviation while D>1.14; thus, it cannot help but change the original optical condition to overcome the problem of the color deviation.

In the prior design, if setting the mentioned wavelength dispersiveness D=1.11 as the starting point, it should modify the optical condition as follows while the wavelength dispersiveness D>1.14: the angle of the upper polarizer (not shown) is about 11˜15°; the angle of the upper retardation film (not shown) is about 65˜69°; the values of Δnd of the uncharged liquid crystal container LCD is reduced to 780˜800 nm; the angle of the lower retardation film (not shown) is about 111˜115°; the angle of the lower polarizer (not shown) is about 75˜79. The result of the modified optical conditions is shown in FIG. 5. FIG. 5 depicts the calculated wavelength separation curve of the white and black image of the modified optical design while the wavelength dispersiveness D=1.16, wherein the problem that black image displaying towards blue is improved, but the white image will also display towards blue. The similar problem will occur even in the optical conditions of different angles, variant phase difference and using the liquid-crystal-coated retardation film.

Based on the above, it is known that how to achieve the high response and the high contrast among the current STN liquid crystal monitor, the TN liquid crystal monitor and the TFT liquid crystal monitor and simultaneously satisfy the necessity of the respective chromaticities of the red subpixel, the green subpixel and the blue subpixel become a major problem waited to be solved. In order to overcome the drawbacks in the prior art, an improved input component is provided. The particular design in the present invention not only solves the problems described above, but also is easy to be implemented. Thus, the invention has the utility for the industry.

### SUMMARY OF THE INVENTION

In accordance with one aspect of the present invention, a designing method for a display module is provided. First, set a predetermined chromaticity value. Second, readjust a respective area distribution among a red subpixel, a blue subpixel and a green subpixel in a pixel to produce a simulated chromaticity value close to the predetermined one. Next, compare the predetermined chromaticity value with the simulated one. Then, repeat the step of adjusting the respective area of the red subpixel, the green subpixel and the blue subpixel until a difference between the predetermined chromaticity value and the simulated one is in a predetermined deviation. By means of adjusting the area distribution among the different subpixels, the chromatic aberration of LCD could be improved. In accordance with another aspect of the present invention, a liquid crystal device is provided. The liquid crystal device is designed based on the mentioned aspect of the invention.

The above aspects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a prior art area distribution diagram among a red subpixel, a green subpixel and a blue subpixel in a color pixel;

FIG. 2 is a data distribution diagram of the wavelength dispersiveness D versus the anisotropic reflection ratio An of a plurality of liquid crystal;

FIG. 3 is the calculated wavelength separation curve of the while and black image while the wavelength dispersiveness D=1.11;

FIG. 4 is the calculated wavelength separation curve of the while and black image while the wavelength dispersiveness D=1.16;

FIG. 5 is the calculated wavelength separation curve of the white and black image of the modified optical design while the wavelength dispersiveness D=1.16;

FIG. 6 is an area distribution among the red subpixel, the green subpixel and the blue subpixel in a color pixel;

FIG. 7 is a real light wavelength separation curve of the LED backlight module;

FIG. 8 is real wavelength separation curve of the red, green and blue filter under the standard light source C;

FIG. 9 is the calculated wavelength separation curve of the white image of the liquid crystal container;

FIG. 10 is the calculated wavelength separation curves of the respective red, green and blue filters under the standard light source C plus the white image of the liquid crystal container; and

FIG. 11 is the calculated wavelength separation curves of all the red, green and blue filters under the standard light source C plus the white image of the liquid crystal container.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

In the beginning, a predetermined chromaticity coordinate is set by modifying the respective area distribution among a red subpixel R1, a green subpixel G1 and a blue subpixel B1 in a pixel rather than modifying the respective chromaticities of the R1, G1 and B1.

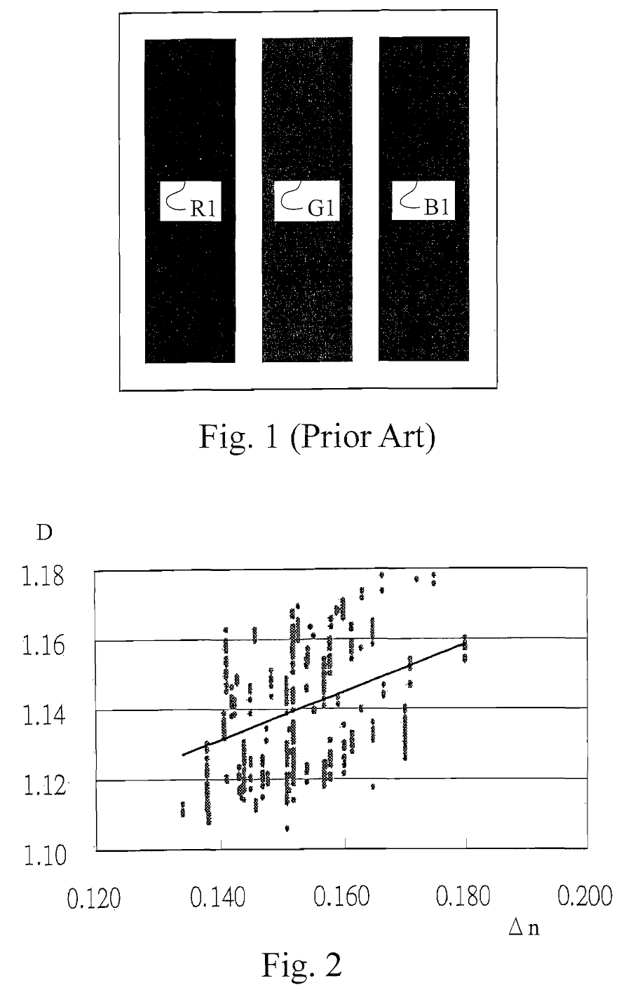

Please refer to FIG. 6, which depicts an area distribution among the red subpixel, the green subpixel and the blue subpixel in a color pixel. Please compare FIG. 6 with FIG. 1, the area of the red subpixel should be raised if the white image is desired to display towards red and the chromaticities of the red subpixel, the green subpixel and the blue subpixel is fixed.

The present designing method for the display module is suitable for the transmissive monitor and the reflective monitor. For the convenience, only the transmissive monitor is exemplified in the following embodiments.

According to the standard JIS Z 8701, a measurement for every 5 nm of the visible wavelength ranged from 380 to 780 nm is obtained and the chromaticity coordinate for 2 degree of view angle of the standard light source C is calculated. The calculated coordinate is (x=0.3101, y=0.3162). Since human eyes are insensitive to the wavelength below 400 nm and above 700 nm as well as the data of the measurements should be simplified, the measurements in every 10 nm of the wavelength range from 400 to 700 nm are accessed and the chromaticity coordinate for 2 degree of view angle of the standard light source C is calculated. The calculated coordinate is (x=0.3100, y=0.3165). The difference between the mentioned two calculated coordinates could almost be neglected. Therefore, the present invention adopts the latter manner to collect data and perform the calculation.

In the liquid crystal monitor, the light is transmitted from the backlight module, passing through the liquid crystal container (not shown) LCD, to human eyes or the detected equipment, wherein the light source and the passed materials will affect the final chromaticity of the product.

The reflective wavelength separation curve is first measured to obtain the different chromaticity of the light source from the backlight module, such as yellow-dependent, optimum or blue-dependent wavelength separation. These reflective wavelength separation curves could be used for the following calculation.

As to the transmissive wavelength separation curve, it is divided into two respective parts to be described. One is the transmissive wavelength separation curve of the color filter; another is the transmissive wavelength separation curve of the transmissive monitor.

The Transmissive Wavelength Separation Curve of the Color Filter

Coat a red color, a green color and a blue color on a respective first, a second and a third glass substrates to manufacture a respective red, a green and a blue filter. Then, allow the incident light passing through the respective red filter, the green filter and the blue filter. The incident light could be one of the backlight module, the standard light source and the selected light source. After the measurements, the respective transmissive wavelength separation curves of the red filter, the green filter and the blue filter in different concentrations are obtained for using in the following calculation.

Then, the transmissive wavelength separation curve of the transmissive monitor is obtained by a simulation and a calculation. After the polarizer, the retardation film and liquid crystal container (including the glass and the liquid crystal layers) LCD is combined, the permeation due to the phase difference might be taken into consideration. Therefore, the factor regarding the phase difference should be represented and further calculated. As for the color STN liquid crystal monitor, the transmissive monitor is constituted by a plurality of optical parts. For example, if the incident light sequentially passes the lower polarizer, the lower retardation film, the liquid crystal container LCD, the upper retardation film and the upper polarizer, the calculations for the respective permeation of each optical part is represented as the following mathematical model of Jones Matrix:

### Polarizer:

$$( \begin{matrix}1 \\ 0\end{matrix} )$$

General retardation film:

$$( \begin{matrix}{e}^{- i Γ / 2} & 0 \\ 0 & {e}^{i Γ / 2}\end{matrix} )$$

Liquid-crystal-coated retardation film or uncharged liquid crystal container

$$LCD \text{:} ( \begin{matrix}cos X - i \frac{Γ sin X}{2 X} & φ \frac{sin X}{X} \\ - φ \frac{sin X}{X} & cos X + i \frac{Γ sin X}{2 X}\end{matrix} )$$

$$wherein Γ = \frac{2 π}{λ} Δ nd , X = \sqrt{{φ}^{2} + {( \frac{Γ}{2} )}^{2}}$$

and φ is the twisting angle of the liquid crystal.

The White and Black Images of the Liquid Crystal Container LCD

Based on the thickness of the cell gap d, the liquid crystal container LCD is regarded as being constituted by N-layers (such as N=40) of the general retardation films. Each layer has its own tilting angle, the value of And and the parameter regarding the long axis of the liquid crystal molecule. Integrating the mentioned conditions, the physical behavior of the permeations of the white and black images of the liquid crystal container LCD could be represented as the mathematic model.

By means of the above mathematic model as well as the suitable conversion of the coordinates, the final transmissive deviation could be calculated and represented as below:

$$( \begin{matrix}{V}_{x} \\ {V}_{y}\end{matrix} ) .$$

Therefore, the permeation could be calculated and represented as (Vₓ)²+(V_{y})². Further, the permeations under different wavelengths build the transmissive wavelength separation database for the transmissive monitor.

Subsequently, introduce at least one theoretical parameter to the mathematic models regarding each permeation among the optical parts. After the real measurement, the at least one real parameter could be obtained. Based on the at least one real parameter, the transmissive wavelength separation curve for each optical part and the transmissive monitor could be produced.

As to the parameter for the mathematic model of the uncharged liquid crystal container LCD, it could be obtained as below. In accordance to the method introduced by Pochi Yeh and Claire Gu, apply the Jones Matrix to calculate the permeation of the incident light passing through one polarizer, the uncharged liquid crystal container LCD and another polarizer. The permeation is represented as

$$T = \frac{1}{2} [ \begin{matrix}{cos}^{2} ( α - β ) - {sin}^{2} X sin 2 β sin 2 α + \\ \frac{φ}{2 X} sin 2 X sin 2 ( α - β ) - {φ}^{2} \frac{{sin}^{2} X}{{X}^{2}} cos 2 β cos 2 α\end{matrix} ] ,$$

wherein α=the incident transmissive angle−the incident aligning angle; β=the reflective transmissive angle−the reflective aligning angle; φ=the twisting angle of the liquid crystal;

$$X = \sqrt{{φ}^{2} + \frac{{( 2 π Δ nd / λ )}^{2}}{4}} ; Δ nd = a + \frac{b}{{λ}^{2}} + \frac{c}{{λ}^{4}} ;$$

and λ=the incident wavelength. The incident light is transmitted from one of the backlight module, the standard light source and the selected light source.

The mentioned mathematic model creates a theoretical permeation curve based on the variants of φ, a, b, c, α; then, after a real measurement, there generates a real permeation curve corresponding thereto. Next, perform a regression calculation of the theoretical permeation curve including the mentioned variants and the real permeation curve to calculate the value of the above five variants. That is, the parameters for the uncharged liquid crystal container LCD are calculated.

Again, it is described how to access the parameters for the mathematic model of the general retardation film and the liquid-crystal-coated retardation film.

1. General Retardation Film:

In accordance to the method introduced by Pochi Yeh and Claire Gu, apply the Jones Matrix to calculate the permeation of the incident light passing through one polarizer, the retardation film and another polarizer. The permeation is represented as

$$T = \frac{1}{2} [ {cos}^{2} ( α - β ) - {sin}^{2} \frac{π \cdot Δ nd}{λ} sin 2 β sin 2 α ] ,$$

wherein α=the incident transmissive angle−the angle of the phase difference; β=the reflective transmissive angle−the angle of the phase difference; λ=the incident wavelength. The incident light is transmitted from one of the backlight module, the standard light source and the selected light source.

Then, the values of the retardation film parameters in its mathematic model are calculated based on the theoretical permeation curve and the real permeation curve.

2. The Liquid-Crystal-Coated Retardation Film

These kind of retardation film creates the delaying effect of the light similar to the uncharged liquid crystal container LCD. Therefore, we adopt the same calculation of the uncharged liquid crystal container LCD to access the parameters for the liquid-crystal-coated retardation film.

Regarding how to access the parameters for the mathematic model of the white and black image of the liquid crystal container LCD, it is similar as the above.

Based on the respective transmissive wavelength separation characteristics of the red filter, the green filter, the blue filter and the transmissive monitor, it is further to build the combined transmissive wavelength separation database.

Depending on the established light source wavelength separation database and the light transmissive wavelength separation database, perform a calculation to produce a predetermined chromaticity value. The predetermined chromaticity value is represented as the chromaticity coordinate in the present embodiments. While applying to the transmissive monitor, the chromaticity coordinate is a transmissive one; while applying to the reflective monitor, the chromaticity coordinate is a reflective one.

In accordance to JIS Z 8701, the calculation of the respective three stimulus values X, Y and Z is described as below:
X stimulus value: X=K∫S(λ) x̅(λ)T(λ)dλ;
Y stimulus value: Y=K∫S(λ) y̅(λ)T(λ)dλ;
Z stimulus value: Z=K∫S(λ) z̅(λ)T(λ)dλ; and

Coefficient

$$K = \frac{100}{\int S ( λ ) \overline{y} ( λ ) d λ} ,$$

wherein S(λ) represents the light source wavelength separation characteristic; x̅(λ), y̅(λ) and z̅(λ) represent the respective function of the X, Y and Z stimulus values; T(λ) represents the transmissive wavelength separation characteristic. Then, the transmissive chromaticity coordinate (x, y) is calculated based on the respective X, Y and Z stimulus values, wherein

$$x = \frac{X}{X + Y + Z} and y = \frac{Y}{X + Y + Z} .$$

To check the accuracy of the calculated Y stimulus value and the transmissive chromaticity coordinate and take the permeation affected by the standard optical parts uncalculated into consideration, perform a real measurement for the backlight module and the white image to produce a luminance, a real Y stimulus value and a real transmissive chromaticity coordinate. Then, compare the calculated values and the measured ones to produce at least one revising coefficient that revises the calculated Y stimulus value and the calculated transmissive chromaticity coordinate.

Further, compare the predetermined chromaticity coordinate and the transmissive chromaticity coordinate until the difference therebetween is within a predetermined deviation, which means the chi-omaticity of the transmissive monitor could satisfy the necessity. If the difference is higher than the predetermined deviation, readjust the respective area distribution of the red subpixel, the green subpixel and the blue subpixel, continue to simulate and produce another transmissive chromaticity coordinate and continue to compare the predetermined chromaticity coordinate and the transmissive one.

Please refer to Table 2, which shows the wavelength separation characteristics of the backlight module, the color filter and the white image of the liquid crystal container. The first column shows the wavelength (nm); the second column shows the wavelength separation characteristics of the backlight module; the third column shows the transmissive wavelength separation characteristics of the red filter; the fourth column shows the transmissive wavelength separation characteristics of the green filter; the fifth column shows the transmissive wavelength characteristics of the blue filter; and the sixth column shows the transmissive wavelength separation characteristics of the white image of the liquid crystal container LCD. The liquid crystal container LCD comprises the glass and the material within the glass, including the liquid crystal layers.

TABLE 2
The wavelength separation characteristics of the backlight module,
the color filter and the white image of the liquid crystal container

| nm | B/L | CF-R | CF-G | CF-B | White image |
|---|---|---|---|---|---|
| 700 | 0.0899 | 0.9042 | 0.2122 | 0.0313 | 0.4800 |
| 690 | 0.1155 | 0.8664 | 0.1543 | 0.0288 | 0.5100 |
| 680 | 0.1462 | 0.8194 | 0.1087 | 0.0274 | 0.5400 |
| 670 | 0.1826 | 0.8301 | 0.0776 | 0.0259 | 0.5600 |
| 660 | 0.2265 | 0.8874 | 0.0606 | 0.0209 | 0.6000 |
| 650 | 0.2753 | 0.8895 | 0.0595 | 0.0140 | 0.6200 |
| 640 | 0.3281 | 0.8428 | 0.0682 | 0.0085 | 0.6600 |
| 630 | 0.3572 | 0.8358 | 0.0796 | 0.0796 | 0.6900 |
| 620 | 0.3202 | 0.8073 | 0.1093 | 0.0034 | 0.7200 |
| 610 | 0.2943 | 0.7781 | 0.1857 | 0.0030 | 0.7600 |
| 600 | 0.2991 | 0.8152 | 0.3203 | 0.0038 | 0.7800 |
| 590 | 0.3401 | 0.6644 | 0.4616 | 0.0057 | 0.8200 |
| 580 | 0.4004 | 0.2703 | 0.5705 | 0.0095 | 0.8500 |
| 570 | 0.4550 | 0.0199 | 0.6366 | 0.0166 | 0.8800 |
| 560 | 0.4544 | 0.0032 | 0.7123 | 0.0352 | 0.9100 |
| 550 | 0.4722 | 0.0022 | 0.7623 | 0.0780 | 0.9300 |
| 540 | 0.4917 | 0.0065 | 0.7716 | 0.1469 | 0.9500 |
| 530 | 0.4931 | 0.0164 | 0.7846 | 0.2342 | 0.9700 |
| 520 | 0.4970 | 0.0113 | 0.7823 | 0.3560 | 0.9800 |
| 510 | 0.3922 | 0.0051 | 0.7496 | 0.4881 | 0.9900 |
| 500 | 0.2977 | 0.0044 | 0.6626 | 0.5830 | 0.9800 |
| 490 | 0.3127 | 0.0052 | 0.5820 | 0.6638 | 0.9700 |
| 480 | 0.5329 | 0.0060 | 0.3453 | 0.7128 | 0.9500 |
| 470 | 1.0000 | 0.0050 | 0.0722 | 0.7290 | 0.9200 |
| 460 | 0.9874 | 0.0054 | 0.0139 | 0.7196 | 0.8700 |
| 450 | 0.9615 | 0.0068 | 0.0110 | 0.7366 | 0.8000 |
| 440 | 0.5135 | 0.0112 | 0.0104 | 0.6999 | 0.7200 |
| 430 | 0.1324 | 0.0180 | 0.0061 | 0.6560 | 0.6200 |
| 420 | 0.0317 | 0.0318 | 0.0113 | 0.6365 | 0.5000 |
| 410 | 0.0107 | 0.0587 | 0.0193 | 0.6320 | 0.3800 |
| 400 | 0.0079 | 0.0987 | 0.0375 | 0.5455 | 0.2600 |

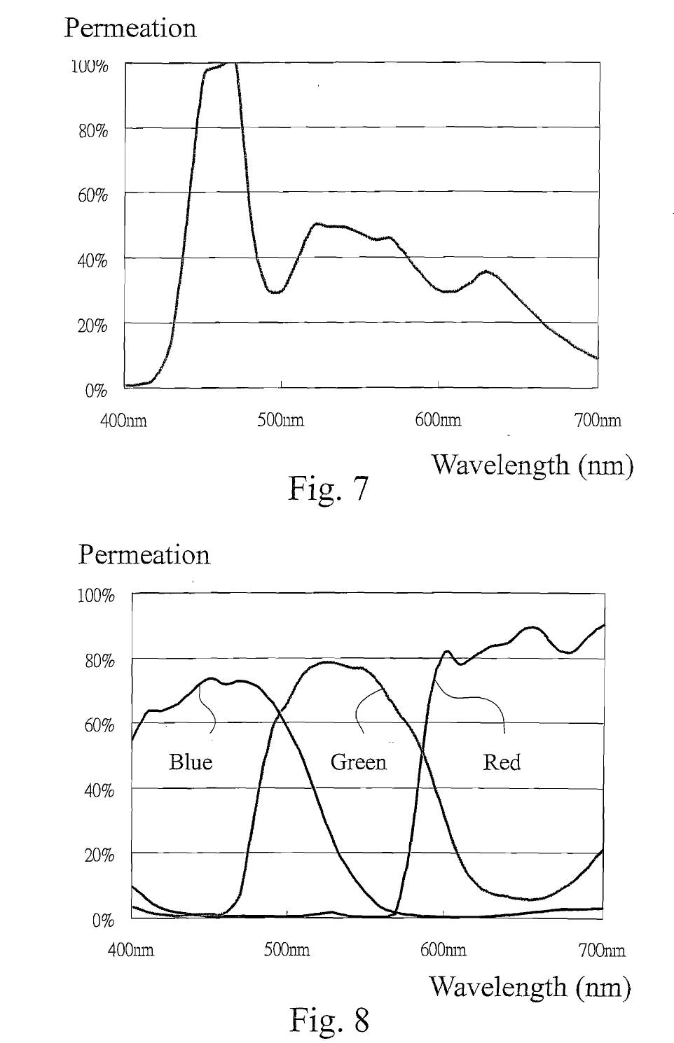

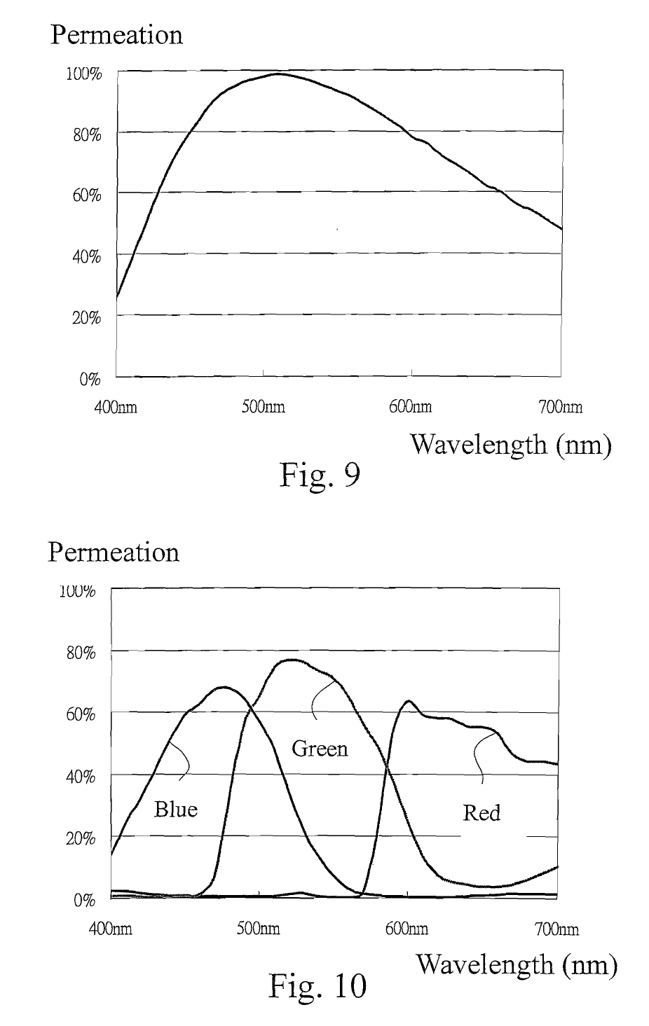

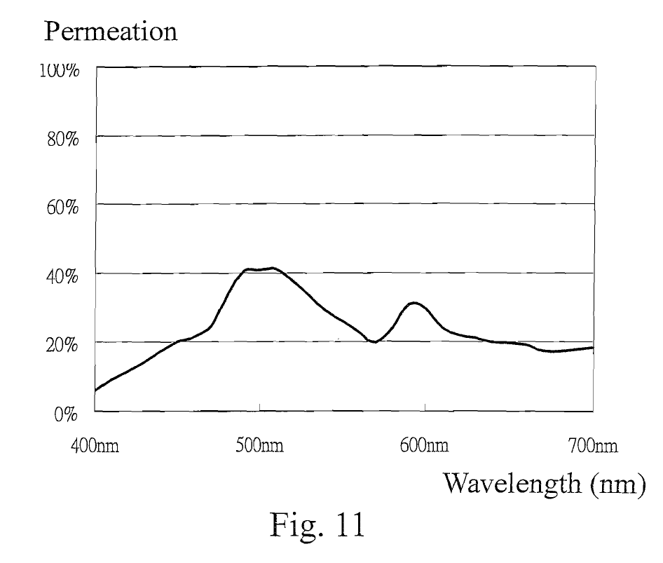

Please refer to FIG. 7, FIG. 8, FIG. 9, FIG. 10 and FIG. 11. FIG. 7 shows a real light wavelength separation curve of the LED backlight module. FIG. 8 shows a real wavelength separation curve of the red, green and blue filter under the standard light source C. FIG. 9 shows the calculated wavelength separation curve of the white image of the liquid crystal container. FIG. 10 shows the calculated wavelength separation curves of the respective red, green and blue filters under the standard light source C plus the white image of the liquid crystal container. FIG. 11 shows the calculated wavelength separation curves of all the red, green and blue filters under the standard light source C plus the white image of the liquid crystal container.

Table 3 shows the respective X, Y and Z theoretical stimulus values while the area ratio among the red subpixel, the green subpixel and the blue subpixel is 1:1:1. The data shown in FIG. 3 is calculated based on the data of Table 2, FIG. 7, FIG. 8, FIG. 9, FIG. 10 and FIG. 11 and the present designing method, wherein the calculation utilizes some parameters to revise the calculated values. The liquid crystal module LCM shown in FIG. 3 comprises the upper polarizer, the lower polarizer, the upper retardation film, the lower retardation film, the liquid crystal container LCD, the backlight source and the electrical circuit. LCM-W represents that the ratio of the luminance of the white image to that of the black image is the biggest, which means the light of RGB region is permeable, and the chromaticity, the permeation and the value of the luminance thereof could be obtained by a calculation or a measurement. If only the light of the R region of the liquid crystal module is permeable, LCM-R is used to represent the red image of the liquid crystal module LCM. Similarly, LCM-G represents the green image of the liquid crystal module LCM and LCM-B represents the blue image of the liquid crystal module LCM. The combination of x and y represents the chromaticity coordinate and Y is the Y stimulus value.

TABLE 3
The simulated data

| | x | y | Y | Luminance | NTSC Ratio |
|---|---|---|---|---|---|
| B/L | 0.280 | 0.294 | — | 5300 | — |
| CF-R | 0.633 | 0.347 | 21.96 | — | 54.49% |
| CF-G | 0.315 | 0.563 | 57.43 | — | |
| CF-B | 0.140 | 0.141 | 15.94 | — | |
| LCM-R | 0.571 | 0.355 | 14.20 | 48 | 48.22% |
| LCM-G | 0.313 | 0.569 | 54.11 | 184 | |
| LCM-B | 0.152 | 0.111 | 15.87 | 54 | |
| LCM-W | 0.272 | 0.334 | 28.06 | — | |
| LCM-W | 0.286 | 0.319 | — | 287 | — |

The present designing method does not completely belong to the theoretical calculation, wherein the parameters are accessed by comparing the real measurement and the theoretical calculation. Then, the theoretical calculation is revised by the parameters. The real value of the luminance of the backlight is measured as 5300 (cd/m²) and the real value of the luminance of the backlight passing through the liquid crystal module LCM is measured as 287 (cd/m²). Therefore, the Y stimulus value of the liquid crystal module is calculated as 28.06, wherein parts of calculations are simplified. For example, the respective permeations of the polarizer, the glass, the insulated film, the aligning film and the liquid crystal are neglected. Moreover, the material will not be easily modified for the stable manufacturing process. Therefore, these simplified calculations could be replaced by one parameter that will not cause a significant deviation. To be more concrete, after the simplified calculation, the white chromaticity of the liquid crystal LCM-W is (0.272, 0.334) and the Y stimulus value is 28.06. As compared with the real measurement, the luminance of the backlight is 5300 (cd/M²) and thus the real white chromaticity coordinate of the liquid crystal LCM-W is (0.286, 0.319) and the luminance of the white image is 287 (cd/m²). Accordingly, we set three parameters as the revising factors. The first one is U=0.00193 (5300*28.06*U=287), the second one is V=1.051 (0.272*V=0.286) and the third one is W=0.955 (0.334*W=0.955). If the material is not modified under different structure designs of the LCD, the parameters U, V and W are quite useful.

In the Table 3, the calculated Y stimulus value of the LCM-R is 14.20, the calculated Y stimulus value of the LCM-G is 54.11 and the calculated Y stimulus value of the LCM-B is 15.87. Therefore, the calculated luminance of the red, the green and the blue image of the liquid crystal module are respectively 48, 184 and 54 (cd/M²).

In the present invention, if the predetermined chromaticity coordinate of the white image is set as (x=0.31, y=0.31), the respective area ratio among the red subpixel R1, the green subpixel G1 and the blue subpixel B1 in a pixel is 1.52:0.92:1.05. That is,

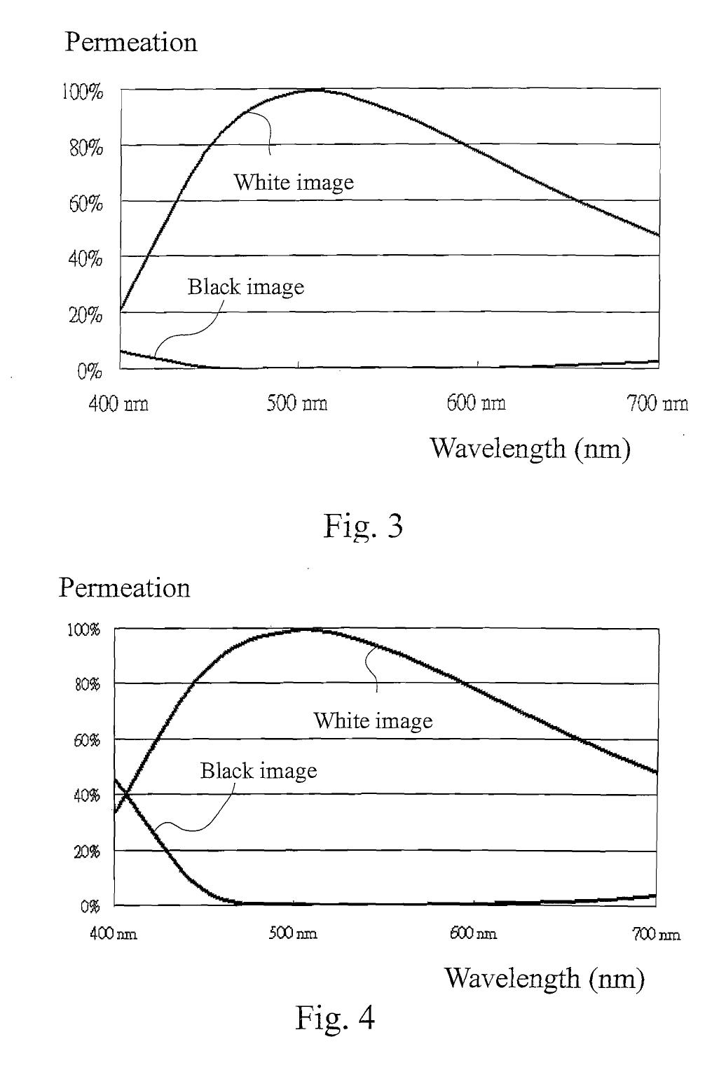

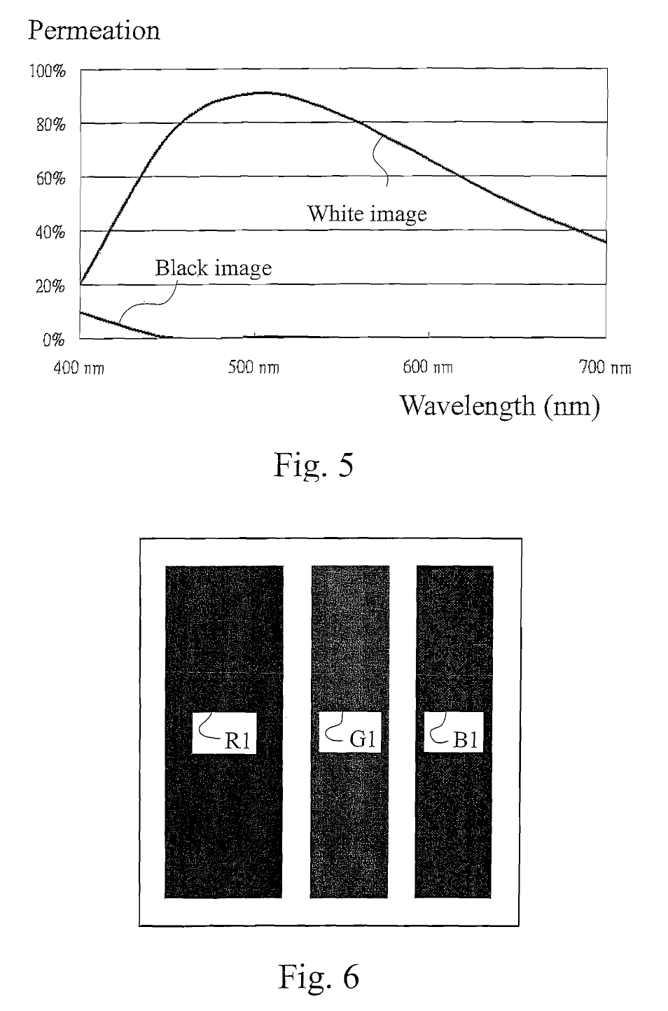

Furthermore, it is known from the illustrations of FIG. 3, FIG. 4 and FIG. 5 that the prior art optical design is hard to solve the problem of the color aberration. However, the designing method disclosed in the present invention first set a predetermined chromaticity value (x, y) of the white image, followed by setting the respective area distribution among the red subpixel R1, the green subpixel G1 and the blue subpixel B1 in a pixel. Then, the wavelength separation characteristics of the white image of the liquid crystal container LCD could be calculated as illustrated in Table 2, followed by performing the real measurement and the calculation to produce the wavelength separation characteristics as illustrated in Table. 3. By means of such readjustment of the respective area distribution and performing a simulated calculation, the desired area distribution of the red subpixel R1, the green subpixel G1 and the blue subpixel B1 could be accessed to overcome the traditional problem of the color aberration.

Moreover, there are many ways to display color, such as the RGB model, the HIS model, the Lab model and the CMYK model. The present method is suitable for adjusting each color element of the mentioned model and is not limited to the adjustment of the chromaticity coordinate. The present invention characterizes in a designing method for a display module and the liquid crystal monitor utilizing the same. The present designing method comprises the steps of setting a predetermined chromaticity value; readjusting a respective area distribution among a red subpixel, a blue subpixel and a green subpixel in a pixel to produce a simulated chromaticity value close to the predetermined one; comparing the predetermined chromaticity value with the simulated one; repeating the step of adjusting the respective area of the red subpixel, the green subpixel and the blue subpixel until a difference between the predetermined chromaticity value and the simulated one is in a predetermined deviation. By means of adjusting the area distribution among the different subpixels, the chromatic aberration of LCD could be improved.

In conclusion, the designing method for the display module of the present invention solves the problem of the color aberration. Accordingly, the present invention can effectively solve the problems and drawbacks in the prior art, and thus it fits the demand of the industry and is industrially valuable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

1. A designing method for a display module, comprising:
(a) setting a predetermined chromaticity value;
(b) producing a simulated chromaticity value by setting a respective area distribution among a red subpixel, a blue subpixel and a green subpixel of a pixel;
(c) comparing the predetermined chromaticity value with the simulated one; and
(d) repeating the steps (b) to (c) until a difference between the predetermined chromaticity value and the simulated one is in a predetermined deviation.

2. A designing method as claimed in claim 1, wherein the step (a) further comprises a step of (a1) converting the predetermined chromaticity value into a predetermined chromaticity coordinate, and the step (c) further comprises steps of:
(c1) converting the simulated chromaticity value into a simulated chromaticity coordinate; and
(c2) producing the simulated chromaticity coordinate being one of a transmissive chromaticity coordinate and a reflective chromaticity coordinate.

3. A designing method as claimed in claim 2, wherein the step (c2) further comprises steps of:
(c21) setting the simulated chromaticity coordinate as the transmissive one;
(c22) building a light source wavelength separation database;
(c23) building a transmissive light wavelength separation database; and
(c24) producing the transmissive chromaticity coordinate.

4. A designing method as claimed in claim 3, wherein the step (c22) further comprises a step of (c221) building the wavelength separation database for a light source of a backlight module, and the step (c23) further comprises steps of:
(c231) manufacturing a red filter on a first glass substrate and producing a first transmissive light wavelength separation sub-database for a transmissive light passing through the red filter;
(c232) manufacturing a green filter on a second glass substrate and producing a second transmissive light wavelength separation sub-database for the transmissive light passing through the green filter;
(c233) manufacturing a blue filter on a third glass substrate and producing a third transmissive light wavelength separation sub-database for the transmissive light passing through the blue filter;
(c234) producing a fourth light transmissive wavelength separation sub-database by means of the transmissive light passing through a transmissive optical machine; and
(c235) building the light transmissive wavelength separation database based on the first, the second, the third and the fourth transmissive separation sub-databases.

5. A designing method as claimed in claim 4, wherein the step (c234) further comprises steps of:
(c2341) building a mathematic model regarding the transmissive light passing through the transmissive optical machine and at least one parameter thereof;
(c2342) performing a regression calculation of the at least one parameter by means of using a theoretical and a real permeation curves obtained from at least one sample;
(c2343) producing the fourth light transmissive wavelength separation sub-database based on the at least one parameter.

6. A designing method as claimed in claim 5, wherein the transmissive optical machine comprises a lower polarizer, an uncharged liquid crystal container and an upper polarizer and the step (c2342) further comprises steps of:
(c23421) allowing the transmissive light subsequently passing through the lower polarizer, the uncharged liquid crystal container and the upper polarizer to produce a first theoretical peuneation sub-curve and a first real permeation sub-curve; and
(c23422) performing a regression calculation of at least a parameter for the uncharged liquid crystal container based on the first theoretical and real permeation sub-curves.

7. A designing method as claimed in claim 6, wherein the transmissive optical machine further comprises a retardation film and the method further comprises steps of:
(c23423) allowing the transmissive light subsequently passing through the lower polarizer, the retardation film and the upper polarizer to produce a second theoretical permeation sub-curve and a second real permeation sub-curve; and
(c23424) performing a regression calculation of at least a parameter for the retardation film based on the second theoretical and real permeation sub-curves.

8. A designing method as claimed in claim 6, wherein the transmissive optical machine further comprises a liquid-crystal-coated retardation film and the method further comprises steps of:
(c23425) allowing the transmissive light subsequently passing through the lower polarizer, the liquid-crystal-coated retardation film and the upper polarizer to produce a third theoretical permeation sub-curve and a third real permeation sub-curve; and
(c23426) performing a regression calculation of at least a parameter for the liquid-crystal-coated retardation film based on the third theoretical and real permeation sub-curves.

9. A designing method as claimed in claim 6, wherein the transmissive optical machine comprises an N-layers liquid crystal for one of a white image and a black image, a lower retardation film and an upper retardation film, and the method further comprises steps of:
(c23427) allowing the transmissive light subsequently passing through the lower polarizer, the N-layers liquid crystal for one of the white image and the black image, the upper retardation film and the upper polarizer to produce a fourth theoretical permeation sub-curve and a fourth real permeation sub-curve; and
(c23428) performing a regression calculation of at least a parameter for the N-layers liquid crystal for one of the white image and the black image based on the fourth theoretical and real transmittance curves.

10. A designing method as claimed in claim 6, further comprising a step of:
setting the liquid crystal container to include a liquid crystal layer.

11. A designing method as claimed in claim 4, further comprising a step of:
setting the transmissive light transmitting from the backlight module.

12. A designing method as claimed in claim 3, wherein the step (c24) further comprises steps of:
(c241) producing respective stimulus values X, Y and Z based on the wavelength separation database and the transmissive wavelength separation database; and
(c242) producing the transmissive chromaticity coordinate based on the respective stimulus values X, Y and Z.

13. A designing method as claimed in claim 12, further comprising a step of:
producing a first coefficient to revise the stimulus value Y.

14. A designing method as claimed in claim 13, further comprising a step of:
producing a second coefficient to revise the transmissive chromaticity coordinate.

15. A designing method as claimed in claim 2, wherein the step (c2) further comprises steps of:
(cc21) setting the simulated chromaticity coordinate as the reflective chromaticity coordinate;
(cc22) building a light source wavelength separation database; (cc23) building a reflective light separation database; and (cc24) producing the reflective chromaticity coordinate.

16. A designing method as claimed in claim 15, wherein the step (cc22) further comprises a step of (cc221) building the light source wavelength separation database for a reflective light source, and the step (cc23) further comprises a step of:
(cc231) building the reflective separation database by means of a transmissive light passing through a red filter, a green filter, a blue filter and a reflective optical machine.

17. A designing method as claimed in claim 16, further comprising a step of:
setting the transmissive light transmitting from the reflective light source.

18. A liquid crystal panel including a display module, wherein the display module is designed by the method as claimed in claim 1.

19. A liquid crystal panel including a display module, wherein the display module is designed by the method as claimed in claim 11.

20. A liquid crystal panel including a display module, wherein the display module is designed by the method as claimed in claim 14.
